(19) United States
(12) Patent Application Publication
(10) Pub. No.: US 2023/0381780 A1
(43) Pub. Date: Nov. 30, 2023

(54) MIXER FOR SMALL VOLUMES

(71) Applicant: Foss Analytical A/S, Hilleroed (DK)

(72) Inventors: Darwin PALIMA, Hilleroed (DK); Soeren Christian PEDERSEN, Hilleroed (DK); Bo Melholt NIELSEN, Hilleroed (DK)

(73) Assignee: Foss Analytical A/S, Hilleroed (DK)

(21) Appl. No.: 18/249,808

(22) PCT Filed: Oct. 13, 2021
(86) PCT No.: PCT/IB2021/059399

§ 371 Date: Apr. 20, 2023

(30) Foreign Application Priority Data
Nov. 12, 2020 (DK) PA202001278

(51) Int. Cl. B01L 3/00; B01F 31/31; B01F 31/20; B03C 1/28; B03C 1/30

(52) U.S. Cl. CPC B01L 3/502761; B01F 31/31; B01F 31/265; B03C 1/288; B03C 1/30; B03C 2201/18; B01F 2101/23

(57) ABSTRACT

A mixer includes a mixing chamber and a motor mechanically connected to the mixing chamber. The mixing chamber comprises a suspended elongate rigid tube section having a top end and an open bottom end, and a flexible tube section extending downwards from the open bottom end. The motor comprises a vibration motor mechanically coupled to the suspended elongate rigid tube section at the top end of the suspended elongate rigid tube section.

### CROSS-REFERENCE TO RELATED APPLICATIONS

This application is a National Stage of PCT/IB2021/059399, filed on Oct. 13, 2021, which claims priority to Danish Patent Application PA202001278, filed on Nov. 12, 2020 in the Danish Patent and Trademark Office, the entire contents of each of which are incorporated herein in their entirety.

### BACKGROUND

The present invention relates to a mixer for small volumes and in particular to a mixer for use mixing a small volumes containing biological media.

Flow cytometry is a well-known technique for making a quantitative determination of the number of biological cells or formed bodies such as bacteria, viruses or fungi (collectively or separately referred to herein as ‘biological media’) in a liquid sample or, more generally, for quantifying the amount of specific analytes in the liquid sample, through bead array immunoassays. Typically, an immunological reaction takes place in which microspheres coated with at least one selected antibody or other specific binding agent are mixed with a sample containing the analyte or biological media of interest.

Immunological reactions of the type with which this invention is concerned include antigen/antibody reactions in which a microsphere, either magnetic or non-magnetic in character, is coated with the antibody, for instance, which will bind specifically with an analyte in free solution. Such a reaction may include a fluorescently labelled analyte which enters a binding competition with analyte in solution, or it may include a detection antibody, either directly fluorescently labelled or labelled through a secondary antibody.

It is known to agitate the mixture of liquid sample and microspheres in order to speed up the reaction. A system for the enumeration of biological media which includes a mixer for providing such an agitation is disclosed in U.S. Pat. No. 5,238,812. The mixer comprises a mixing chamber which is permanently sealed at one end and which has an internal volume dimensioned for holding from around 5 microliters to around 1,000 microliters of liquid sample containing analyte(s) of interest, such as cells, and at least one reactant including microspheres with specific binding agent, such as antibodies, bonded thereto which is specific to one or more of the analyte(s) of interest; and a rotational motor mechanically connected to the mixing chamber via a cam and follower arrangement to induce an oscillatory motion of the mixing chamber and thereby effect a mixing of the liquid sample and reactant. The mixer disclosed in U.S. Pat. No. 5,238,812 further includes means for performing a separation of some of said analyte(s) of interest which have become bound to the microspheres from said sample immediately following said mixing. Such means include magnetic means when the microspheres used are magnetic microspheres. Separated analyte, for example cells, are then passed to a connected particle counter for enumeration in a known manner.

The motor and cam/follower arrangement is relatively complex and relatively inefficient, requiring a relatively large motor to drive the motion of the mixing chamber. All of which tend to mitigate against integrating such a mixer in a system for the enumeration of biological media.

### SUMMARY

It is an aim of the present invention to provide a mixer for small volumes that may be included in a system for the enumeration of biological media which at least alleviates one of the problems associated with the known mixer.

According to a first aspect of the present invention there is provided a mixer for small volumes comprising a mixing chamber, preferably configured to provide an internal volume to hold between from around 5 microliters to around 1,000 microliters of liquid sample containing one or more analytes of interest and at least one reactant including microspheres with antibodies or other binding agents bonded thereto specific to one or more of the analytes of interest; and a motor mechanically connected to the mixing chamber to induce an oscillatory motion thereof when actuated; wherein the mixing chamber comprises a suspended elongate rigid tube section having a top end and an open bottom end, and a flexible tube section, such as may be provided by a connected separate length of tube, for example a silicone rubber tube, extending downwards from the open bottom end and fixedly located towards an end distal the open bottom end; and wherein the motor comprises a vibration motor, such as an eccentric rotating mass (ERM), motor mechanically coupled to the elongate rigid tube section towards the top end to provide, when actuated, an oscillatory circular motion to the mixing chamber. The need for a cam and follower arrangement is thereby eliminated. Moreover of a vibration motor directly attached to the mixing chamber allows the overall size of the mixer to be made relatively smaller.

In some embodiments the vibration motor and the mixing chamber are mutually configured with an oscillating frequency of the vibration motor at or close to the resonant frequency of the mixer. Being close to resonance permits large amplitude oscillatory motion by imposing a relatively small force compared to that needed for the same motion off resonance. Further, the driving force need not identically follow the circular path.

In some embodiments a biasing means such as a spring may be provided to generate a known, usefully variable, tension in the flexible tube section. This enables the resonant frequency of the mixer to be tuned to better match the oscillating frequency of the vibration motor.

In some embodiments the flexible tube section has a length selected to tune the resonance frequency of the mixer to match or nearly match the oscillating frequency of the vibration motor.

In some embodiments the rigid tube section is tapered towards the bottom end and may usefully be formed from a pipette tube. This may facilitate the connection to a narrow flexible tube section at the bottom and be better suited for handling small liquid volumes, while having a wide enough diameter at the upper end of the taper to allow formation of a vortex when swirled in a circular pattern when the vibration motor is actuated. Furthermore, the taper ensures that the entire volume of liquid may be evacuated after mixing and possibly magnetic separation of microspheres from the liquid.

The terms up, down, top and bottom as used herein are made with reference to the direction of gravity.

According to a second aspect of the present invention there is provided system for enumerating analytes comprising a plurality of liquid containers; a sample intake; a flow cytometer; a mixer according to the first aspect of the present invention and a multi-way selector valve configured to selectively complete flow-paths within the system to connect the mixer to individual ones of the plurality of the liquid containers, to the sample intake and to the flow cytometer.

### BRIEF DESCRIPTION OF THE DRAWINGS

The foregoing, as well as additional objects, features and advantages of the present invention, will be better understood through the following illustrative and non-limiting detailed description of embodiments of the present invention, made with reference to the appended drawings, of which:

FIG. 1 is an illustration of an embodiment of the mixer of the present invention; and

FIG. 2 is a schematic block diagram of a system for enumerating particles including a mixer according to the present invention.

### DETAILED DESCRIPTION

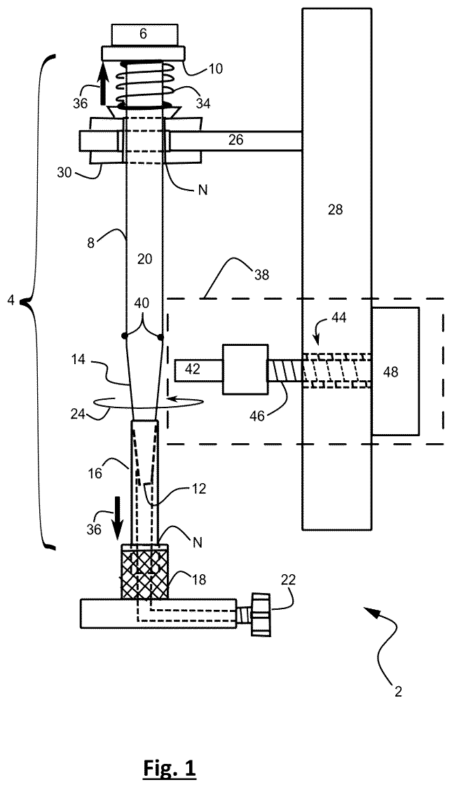

A mixer 2 according to the present invention is illustrated in FIG. 1. The mixer 2 comprises a mixing chamber 4 and a vibration motor 6, such as a known eccentric rotating mass (or ‘ERM’) motor.

The mixing chamber 4 is made up of an elongate rigid tube section 8 having a top end 10 and an open bottom end 12 which, in some embodiments may be constructed as an aperture through an otherwise solid bottom end 12. The elongate rigid tube section 8 is, in the present embodiment, provided with a portion 14 having a cross-section which tapers towards the open bottom end 12. The mixing chamber 4 is also made up of a flexible tube section 16 which extends downwards from the open bottom end 12. The flexible tube section 16 is secured towards its end which is distal the open bottom end 12, in the present embodiment to a fixed fluid port 18. The fixed fluid port 18 provides external access to and from the internal volume 20 of the mixing chamber 4 via the flexible tube section 16 and the open bottom end 12. In the present embodiment, a coupling 22 is provided for connection of the internal volume 20 of the mixing chamber 4 to external flow conduits (not shown) via the fixed fluid port 18. The flexible tube section 16 may in some embodiments, as illustrated in FIG. 1, be provided as a separate section, such as by a silicone tubing section and may be push-fit connected to the open bottom end 12 of the rigid tube section 8.

The vibration motor 6 is mechanically coupled to the top end 10 of the elongate rigid tube section 8 of the mixing chamber 4 to drive the mixing chamber 4 in an oscillatory circular motion, as illustrated by the arrow 24, when actuated. This motion provides a vortex mixing effect on material in the internal volume 20.

As is illustrated in FIG. 1, the elongate rigid tube section 8 may be suspended vertically from a rigid tube mount arm 26 which holds the elongate rigid tube section 8 at a location towards its top end 10. The rigid tube mount arm 26 in some embodiments, as illustrated in FIG. 1, extends horizontally from a mounting bracket 28 and may be provided with a resilient bushing 30 for holding the rigid tube section 8.

In some embodiments, as illustrated in FIG. 1, a biasing means, such as spring 34 may be provided to provide a force, as illustrated by arrows 36, which acts to vary the length of the flexible tube section 16 and hence the tension in the mixing chamber 4. Usefully, the biasing means, here as realised by spring 34, may be adapted to provide an adjustable force and hence an adjustable tension in the mixing chamber 4. In other embodiments the tension may be created through the elastic properties of the flexible tube section 16 itself, for example the rigid tube section 8 may be held so that the flexible tube section 16 is stretched along its length to generate a restoring force tending to return the flexible tube section 16 to its natural length and thereby create a tension in the mixing chamber 4.

On actuation of the vibration motor 6 periodic vibrations are generated in a known manner which are transmitted to the mixing chamber 4 via the top end 10 of the rigid tube section 8. These vibrations will induce the mixing chamber 4 to oscillate with the mixing chamber 4 having fixed, nodal points N where the rigid tube section 8 connects with and is held by the resilient bushing 30 and where the flexible tube section 16 is secured to the fixed fluid port 18 and an anti-nodal point (not shown) towards the open bottom end 12). The mixer 2 will possess a resonant oscillation frequency which is dependent on, amongst other things, the length, the tension and the inertial mass of the moving parts, including that of the vibration motor 6. If this resonant oscillation frequency is at the same frequency as the periodic vibrations generated by the vibration motor 6 the amplitude of oscillation of the mixing chamber 4 will be reinforced by the vibrations generated by the vibration motor 6. It will be appreciated that a proper selection, such as may be achieved through reasonable trial and error, of one or both the tension in the mixing chamber 4 and the length of the flexible tube section 16 will result in the resonant oscillation frequency matching or closely matching that of the periodic vibrations. Thus a better vortex mixing may be achieved at relatively lower power input to the vibration motor 6 than would be the case if the two frequencies were not equal or not nearly the equal. In embodiments where the vibration motor 6 is an ERM motor, it is well known that adjusting the DC voltage powering the vibration motor 6 will adjust the period of vibrations produced by the vibration motor 6. This may provide an additional or alternative means to help closely match the frequency of the periodic vibration produced by the vibration motor 6 and the resonant frequency of oscillation of the mixer 2.

In some embodiments, as illustrated in FIG. 1, the mixer 2 may include a magnetic separation mechanism 38 which may be activated to generate a magnetic field within at least a portion of the internal volume 20 of the mixing chamber 4 to thereby attract any magnetic particles within that internal volume 20 to an inside wall of the mixing chamber 4, removing them from suspension in any liquid within that internal volume 20. In some embodiments, as illustrated in FIG. 1, the magnetic separation mechanism 38 comprises a number of permanent bar magnets 42 attached to a linear drive mechanism 44, such as a worm drive 46 and motor 48 which may be attached to the mounting bracket 28. The linear drive mechanism 44 may be realised in other known manners, such as by using a linearly moveable hydraulic actuator. The linear drive mechanism 44, when actuated, operates to move the bar magnets 42 relative to the mixing chamber 4 in order to bring the mixing chamber 4 into or out of the magnetic field created by those bar magnets 42. In some embodiments the bar magnets 42 may be replaced with one or more electromagnets fixedly located to at least partially encircle a portion of the mixing chamber 4 and energisable to selectively generate the magnetic field to attract magnetic particles which may be suspended in liquid within the internal volume 20.

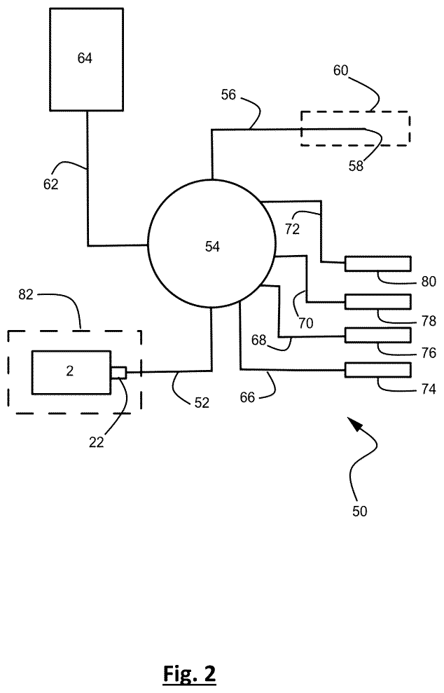

A system 50 for enumerating analytes of interest is illustrated schematically in FIG. 2 and includes a mixer 2 according to the first aspect of the present invention. Here, by way of example only, the mixing chamber 4 of the mixer 2 is provided with an internal volume 20 capable of holding between around 4 microliters to around 1,000 microliters, typically between around 250 microliters to around 400 microliters, of liquid sample containing one or more analytes of interest and a reactant including microspheres, here magnetic microspheres, with antibodies or other binding agent bonded thereto that are specific to one or more of the one or more analytes of interest. The system 50 further comprises a flow conduit 52 connected to the coupling 22 and to a multi-way selector valve 54. An intake conduit 56 is also connected to the multi-way selector valve 54 and has an end 58 for insertion into a liquid sample container 60. A delivery conduit 62 is provided which connects the multi-way selector valve 54 with a flow cytometer 64 of know type. A number (here four, for example) other conduits 66,68,70,72 are provided with each connected to an own container 74,76,78,80 holding various reagents and other liquids necessary for use in the system 50. In particular, one container, 74 say, may hold binding agent (for example antibody) coated magnetic microspheres in suspension; another container, 76 say, may hold a fluorescently labelled analyte in suspension; another container, 78 say, may hold a dilutant; and another container, 80 say, may hold a rinsing liquid. Other containers may be provided as required for the proper operation of the system 50. A thermostated housing 82 may also be provided in some embodiments for housing the mixer 2 and holding it at a predefined reaction temperature to facilitate reaction between analyte and microspheres in the mixing chamber 4.

The multi-way selector valve 54 is configured in a known manner to selectively complete various flow-paths within the system 50 to supply as necessary, sample from the sample container 60 into the mixer 2; reactant into the mixer 2 which reactant, in the present exemplary embodiment, comprises a first reactant, here binding agent coated magnetic microspheres from container 74, and a second reactant, here fluorescently labelled analyte from container 76; dilutant from container 78 and rinsing agent from container 80 into the mixer 2; and magnetic microspheres in suspension from the mixer 2 into the flow cytometer 64.

The system 50 also comprises other liquid conduits and pumping systems (not shown) common in the art and necessary to effect transport of the various liquids and suspensions within the system 50 during its operation.

In one embodiment of the system 50 appropriate volumes of the reactant and sample are taken from the different sources described above and into the flow conduit 52 in the amounts in the ranges: 10-150 microliters magnetic microspheres in suspension, 10-150 microliters fluorescently labelled analyte, and 30-100 microliters of the sample from sample container 60, separated, such as by introducing air gaps in the flow conduit 52, to prevent premature reaction. These components are then pushed to the mixing chamber 4 where they are mixed, to remove the air gaps when employed, and ensure good mixing. The internal volume 20 of the mixing chamber 4 is over-dimensioned compared to the volume of the components to be mixed in order to accommodate the rise of liquid in the mixing chamber 4 as the rigid tube section 8 is swirled to create a vortex. An internal volume of around 1000 microliters is employed in this embodiment but this may be empirically adjusted in other embodiments, perhaps following observation, to suit the physical properties of the liquids affecting their motion, viscosity for example, and the volumes expected to be present in the system 50. After mixing, the contents of the mixing chamber 4 is then left to incubate for between approximately 15 seconds to 3 minutes (incl. the mixing time and magnetic capture time) while the thermostated housing 82 maintains the desired reaction temperature, typically between 30° C. to 60° C. The incubation time and temperature are known to be generally interrelated and depend also on the reaction type. Therefore, the time and the temperature may be determined empirically through reasonable experimentation. During this incubation, the fluorescently labelled analytes compete with analytes in the sample for capture by the binding agent attached to the magnetic microspheres. This means that higher analyte concentration in the sample result in less fluorescently labelled analyte being captured and vice versa. After incubation the magnetic microspheres are captured by activating the magnetic separation mechanism 38 of the mixer 2 to generate a magnetic field within the mixing chamber 4, the excess reaction liquid is removed from the mixing chamber 4 via the fixed fluid port 18 and disposed of to waste to be replaced in the mixing chamber 4 by a similar amount of a re-suspension liquid (also connected to the fixed fluid port 18 of the mixer 2 via the multi-way selector valve 54) which may, for example, be the dilutant from container 78 or which may be a different liquid. The magnetic separation mechanism 38 is then deactivated, removing the magnetic field from within the mixing chamber 4, the re-suspension liquid in the mixing chamber 4 is rigorously mixed bringing the captured magnetic microspheres into suspension.

Next the multi-way selector valve 54 is operated to fluidly connect the fixed fluid port 18 of the mixing chamber 4 with the flow cytometer 64 via the delivery conduit 62 and suspended microspheres are transported into the flow cytometer 64 which operates to measure fluorescence intensities from the microspheres. In this embodiment two fluorescence colours are monitored during this process: (1) the brightness of the fluorescently labelled analyte (2) the brightness of the microsphere fluorescence. The microsphere fluorescence helps to distinguish microspheres from noise while the fluorescently labelled analyte brightness indicates how much labelled analyte attached to the microspheres during incubation. In, for example, a multiplex assay, microspheres with multiple different fluorescence levels are used, one level for each analyte of interest. This unique level enables identifying the labelled analyte's fluorescence for each of the multiple different analytes even when analytes have the same fluorescent label.

1. A mixer, comprising:
a mixing chamber, the mixing chamber including
a suspended elongate rigid tube section having a top end and an open bottom end, and
a flexible tube section extending downwards from the open bottom end; and
a motor mechanically coupled to the mixing chamber, the motor configured to induce an oscillatory motion of the mixing chamber based on the motor being actuated, wherein the motor includes a vibration motor mechanically coupled to the suspended elongate rigid tube section at the top end of the suspended elongate rigid tube section.

2. The mixer of claim 1, wherein the vibration motor and the mixing chamber are mutually configured to cause an oscillating frequency of the vibration motor to be equal to a resonant frequency of the mixer.

3. The mixer of claim 2, wherein the resonant frequency of the mixer is tuned to be equal to the oscillating frequency of the vibration motor based on a length of the flexible tube section.

4. The mixer of claim 1, wherein the flexible tube section includes a flexible tube that is separate from the suspended elongate rigid tube section and is connected to the open bottom end of the suspended elongate rigid tube section.

5. The mixer of claim 1, wherein the suspended elongate rigid tube section includes a tapering cross section portion that tapers to the open bottom end.

6. The mixer of claim 1, further comprising a biasing means configured to create a tension in the mixing chamber.

7. The mixer of claim 1, further comprising a magnetic separation mechanism configured to selectively generate a magnetic field within at least a portion of an internal volume of the mixing chamber.

8. The mixer of claim 1, wherein the mixing chamber has an internal volume configured to hold between around 4 microliters to around 1,000 microliters of a liquid sample, the liquid sample containing
one or more analytes of interest, and
at least one reactant including microspheres with binding agent bonded thereto specific to the one or more analytes of interest.

9. A system for enumerating analytes, the system comprising
the mixer of claim 1;
a plurality of liquid containers;
a sample intake;
a flow cytometer; and
a multi-way selector valve configured to selectively complete flow-paths within the system to selectively connect the mixer to one of
a selected, individual liquid container of the plurality of the liquid containers,
the sample intake, or
the flow cytometer.

10. the mixer of claim 6, wherein a resonant frequency of the mixer is tuned to be equal to an oscillating frequency of the vibration motor based on a particular magnitude of the tension in the mixing chamber that is created by the biasing means.
